(19) United States
(12) Patent Application Publication
(10) Pub. No.: US 2015/0208641 A1
(43) Pub. Date: Jul. 30, 2015

(54) DECOY SUPPORT

(71) Applicant: Albert H. Gurner, III, Salisbury, NC (US)

(72) Inventor: Albert H. Gurner, III, Salisbury, NC (US)

(21) Appl. No.: 14/586,402

(22) Filed: Dec. 30, 2014

Related U.S. Application Data
(63) Continuation-in-part of application No. 13/427,743, filed on Mar. 22, 2012, now abandoned.

(51) Int. Cl. A01M 31/06; F16M 13/02; F16M 11/08; A01M 31/00

(52) U.S. Cl. CPC A01M 31/06; A01M 31/00; F16M 13/02; F16M 11/08

(57) ABSTRACT

The present invention provides a motorized decoy support for positioning and imparting movement to decoy bodies such as game bird decoy bodies. The decoy support includes a stake that includes a housing positioned at one end of the stake. A power-supply unit is configured to be received within the housing. A shaft for transmitting motion extends from the power-supply unit and includes an end configured to receive a light emitting source such that the source is substantially not visible from the side but is visible from a position along an extended imaginary axis of the shaft.

### PRIORITY

This application claims priority from and is a continuation in part of U.S. Non-Provisional patent application Ser. No. 13/427,743 that was filed on Mar. 22, 2012 and which claims priority from U.S. Provisional Pat. App. Ser. No. 61/466,953 that was filed on Mar. 24, 2011 and that are both incorporated herein in their entirety.

### FIELD OF THE INVENTION

The invention relates generally to movable decoys and more specifically to a motorized support for a decoy for simulating motion of turkeys and the like.

### BACKGROUND OF THE INVENTION

Decoys for luring game birds are an important part of hunting. In particular, decoys are useful for particular species of birds such as turkey or geese. Certain characteristics of a decoy are especially important for luring a predetermined species. These characteristics can include size, position, coloration, silhouette, surrounding context, and motion. Conventional decoys are configured to embodiment at least one of these characteristics.

One problem with known decoys for game birds is that they do not replicate motion in a manner that is sufficiently natural to lure wary species.

Another problem with conventional decoys that do employ motion is that they can be mechanically complex. It is believed that as a result, such decoys are susceptible to malfunctioning. Such failures in the field compromise the decoys ability to attract game.

Another problem with conventional decoys is that they might be difficult to set up prior to a hunt. Decoys are often set up in less than ideal weather conditions. Such conditions can include low or no light due to time of day, tree cover, cloud cover, or other obstructions to light.

Another problem with conventional motorized decoys is that they may be expensive. Excessive cost of a decoy can have substantial impact on a hunt, particularly when several decoys are deployed.

### SUMMARY OF THE INVENTION

Accordingly, the present invention provides a motorized support for a decoy configured to address the foregoing problems. More specifically, the present invention provides a support configured to retain a motor and decoy such that the decoy can be easily transported, positioned in the field, and activated to attract game birds such as turkeys.

According to one embodiment of the present invention, there is provided a motorized decoy support for positioning and imparting movement to decoy bodies such as game bird decoy bodies. The decoy support includes a stake that includes a housing positioned at one end of the stake. A power-supply unit is configured to be received within the housing. A shaft for transmitting motion extends from the power-supply unit and includes a tip configured to engage a decoy body and the tip is configured to emit light in this regard, a source for emitting light is recessed within the tip such that the source is substantially obscured when the tip is viewed from the side.

According to one aspect of the present invention, the tip includes a light emitting diode.

According to one aspect of the present invention, the tip is configured to have enhanced visibility in low-light conditions.

According to one aspect of the present invention, the tip is coated with a light emitting substance.

According to one aspect of the present invention, the light emitting substance is phosphorescent.

According to one aspect of the present invention, the light source is recessed within the tip.

According to another aspect of the present invention, the tip includes walls that form a cup-shaped space at the tip of the shaft.

According to another aspect of the present invention, the walls are annular.

According to another aspect of the present invention, the annular walls are substantially concentric with an imaginary extension of the axis of the shaft.

According to another aspect of the present invention, the light source is positioned with the cup-shaped space.

According to another embodiment of the present invention, there is provided a method for installing a decoy for a game bird. The method includes the steps of: A) providing a stake that includes a housing positioned at one end of the stake, a power-supply unit configured to be received within the housing, a shaft for transmitting motion extending from the power-supply unit, wherein the shaft includes a tip configured to engage a decoy body and the tip is configured to emit light; B) providing a decoy body and a nut configured to secure the decoy body to the tip; C) pushing the stake into ground; D) positioning the power supply unit within the housing; E) aligning the tip with an opening defined in the decoy body; F) aligning the tip with the nut; and G) securing the body to the tip and thus to the motor and stake by securing the nut to the tip.

According to one aspect of the present invention, the method includes the further step of activating the power unit.

According to one aspect of the present invention, the method includes the further step of visually determining the location of the tip relative to the opening with the aid of light emitted from the tip.

According to one aspect of the present invention, the method includes the further step of visually determining the location of the tip relative to the nut with the aid of light emitted from the tip.

According to one embodiment of the present invention, there is provided a decoy for luring game birds. The decoy includes a stake that includes a housing positioned at one end of the stake; a power-supply unit configured to be received within the housing; a shaft for transmitting motion extending from the power-supply unit; and a body configured to simulate a game bird. The shaft includes a tip configured to engage the body and the tip is configured to emit light.

According to one aspect of the present invention, the decoy further comprising graphics position on the stake that realistically simulate game bird legs.

According to one aspect of the present invention, the power-supply unit is an electric motor.

According to one aspect of the present invention, the motor is powered by a D battery.

### BRIEF DESCRIPTION OF THE DRAWINGS

For a fuller understanding of the nature and objects of the present invention, reference should be made to the following detailed description taken in connection with the accompanying drawings, wherein:

FIG. 1 is a side view of a partially-cutaway game bird decoy positioned on a post configured in accordance with one embodiment of the preferred invention;

FIG. 2 is an exploded view of the partially-cutaway game bird decoy and the post according to the embodiment shown in FIG. 1;

FIG. 3 is an exploded view of a partially-cutaway game bird decoy and a post according to an alternative embodiment of the preferred invention shown in FIG. 1;

FIG. 4 is a exploded view of a partially-cutaway motor and post assembly of a game bird decoy post according to another embodiment of the present invention;

FIG. 5 is a perspective partial view of a top portion according to the embodiment of the present invention shown in FIG. 4;

FIG. 6 is a side view of a post that extends from the top potion that is shown in FIG. 5 and the post includes a recess formed in on end wherein the recess is configured to receive a light source;

FIG. 7 is a top view of the post shown in FIG. 6;

FIG. 8 is a cut-away view of the post shown in FIGS. 6 and 7 taken along line 8-8;

FIG. 9 is a side view of the post that extends from the top potion that is shown in FIG. 6 and in this view, a light emitting substance is positioned in the recess;

FIG. 10 is a top view of the post shown in FIG. 9;

FIG. 11 is a cut-away view of the post shown in FIGS. 9 and 10 taken along line 11-11;

FIG. 12 is a perspective view of another embodiment of a post section of a top portion according to another embodiment of the present invention; and

FIG. 13 is an exploded view of the post shown in FIG. 12.

### DETAILED DESCRIPTION OF THE PREFERRED EMBODIMENTS

Embodiments of the present invention are directed to a support configured to retain a motor and decoy such that the decoy can be easily transported, positioned in the field, and activated to attract game birds such as turkeys. The support is also configured to be easily and economically manufactured and maintained.

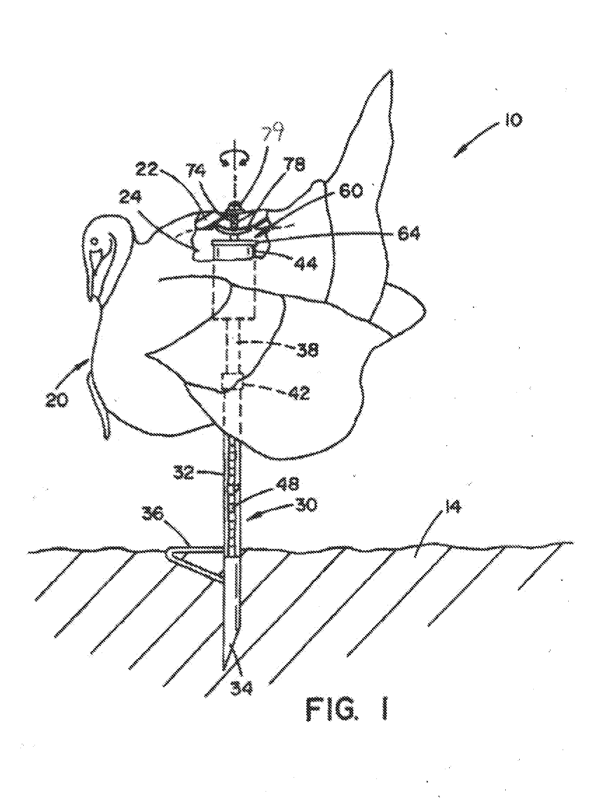

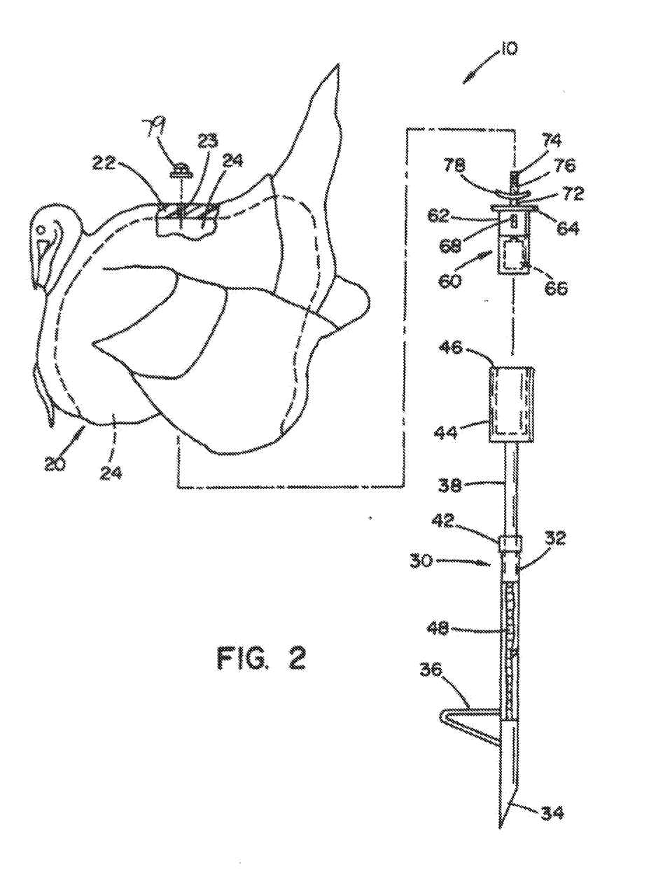

Referring to FIGS. 1 and 2, in accordance with an embodiment of the invention, a motorized decoy 10 includes a stake 30 that is configured to be inserted into ground 14 such that a decoy body 20 is supported. Body 20 includes a wall 22 that defines a cavity 24. An opening 23 is formed in wall 22 such that an attaching tip 74 of stake 30 can extend therethrough.

In addition to attaching tip 74, stake 30 also includes a shaft 32 that has a ground tip 34. Ground tip 34 is positioned on an end of shaft 32. Ground tip 34 is configured to be retained within ground 14 and in the illustrated embodiment ground tip 34 is shaped to better enable insertion into ground 14. A step 36 extends substantially perpendicularly away from shaft 32 and is configured to provide a leverage position such that tip 34 of shaft 32 can be pushed into ground 14. In this regard, a user would place their foot on step 36.

Shaft 32 has an exterior surface that has graphics 48 positioned thereon. In the illustrated embodiment, graphics 48 are chosen to mimic the legs of a turkey. It should be appreciated that graphics 48 could be chosen to mimic a portion of a turkey or other game bird in a realistic manner or in an abstract manner. In this regard, graphics 48 and the exterior surface shape and contour of shaft 32 are generally chosen to be perceived by a game bird such that the appearance of shaft 32 does not spook, and even assists in attracting, the game bird to a desired location.

Continuing to refer to FIGS. 1 and 2, a rod 38 is configured to be received within shaft 32 and extend therefrom such that the overall length of stake 30 can be adjusted to a predetermined length. Rod 38 is retained in position relative to shaft 32 by a collet 42 or other retention device. Stated another way, stake 30 is configured to be telescoping and the length of stake 30 can be fixed by operation of collet 42.

Rod 38 includes a housing 44 that is formed in an end of rod 38 positioned away from shaft 32. Housing 44 is substantially cup-shaped in the illustrated embodiment and includes a rim 46. Housing 44 is configured to receive a power unit 60. Power unit 60 is configured to cause body 20 to rotate or otherwise move. In the illustrated embodiment, power unit 60 is an electric motor 62. Motor 62 includes a annular flange 64 that engages rim 46 of housing 44. In the preferred embodiment motor 62 powered by a battery 66 but in other embodiments it can be powered by photovoltaic cells or a supply of alternating current from a generator or power grid. Preferably, battery 66 is a D battery. A switch 68 is provided such that power to motor 62 from battery 66 or other power source can be regulated. It should be appreciated that switch 68 can be activated manually or that circuitry can be provided such that power unit 60 is remotely activated by wire or wirelessly.

In alternative embodiments, power unit 60 is configured to store potential energy by mechanical means such as a spring or elastic band. In these embodiments the retained energy is converted to kinetic energy with the storage means is released. In some embodiments an escapement is configured to regulate the released of energy such that the motion of body 20 is within predetermined speed or other limits.

Motor 62 includes a motor shaft 72 that extends therefore such that motion and power can be transmitted from motor 62 via shaft 72 to body 20. Shaft 72 extends from motor 62 to attaching tip 74. Attaching tip 74 is threaded for receiving an attachment device, a nut 79, that is configured to securely engage wall 22 of body 20 to a securement 78. Securement 78 is configured to secure body 20 relative to the shaft such that body 20 is configured to move with shaft 72. By way of example and not limitation, securement 78 can include the following: a claw, a prong, a spike, high friction pad or gasket, and a combination thereof. Securement 78 is configured such that it feature that it engages shaft 72 with a complementary shape in a manner that limits or prohibits motion of securement 78 relative to shaft 72. Likewise, in a preferred embodiment power unit 60 and housing 44 are configured such that power unit 60 cannot rotate relative to housing 44. Such configuration can include overall shape or a complimentary key and slot.

A light emitting element 76 is positioned on attaching tip 74. Light emitting element 76 can be an electrically powered light source such as a light emitting diode or LED or incandescent bulb. In a preferred embodiment, light emitting element 76 is phosphorescent. Alternatively light emitting element 76 can be chemi-luminescent. Light emitting element 76 is configured to provide for location of tip 74 by a user during the process of attaching nut 79 to tip 74 to secure body 20 to power unit 60 and ultimately to stake 30. It has been found that light emitting element 76 can be sufficiently bright to aid in placing body 20 on stake 30 during low light conditions yet not be so bright as to give away the position of the hunter or otherwise affect the hunt. In short, light emitting element 76 is a glow-in-the dark feature.

The present invention can be better understood by a description of the operation thereof. Motorized decoy 10 can be transported by a hunter to the site of the hunt disassembled such that body 20, stake 30, and power unit 60 are not in the final configuration. When the desired location is reached, the user pushes stake 30 into the ground using step 36. The location is chosen with regard to the immediate landscape and other decoys, if any. After stake 30 is inserted into ground 14, rod 38 is positioned such that attaching tip 74 is a predetermined distance from the ground 14. Collet 42 is secured such that rod 38 is held substantially in positioned relative to shaft 32. In this manner, stake 30 is positioned at a predetermined length.

Power unit 60 is then positioned in housing 44. Light emitting element 76 is activated if necessary and body 20 is positioned such that attaching tip 74 extends through opening 23 of body 20. Nut 79 is placed onto attaching tip 74 such that securement 78 is engaged with body 20 and body 20 is secured to stake 30. Switch 68 is then activated such that power unit 60 provides motion to body 20. In this manner motorized decoy 10 is initiated and installed such that can game birds can be attracted thereto.

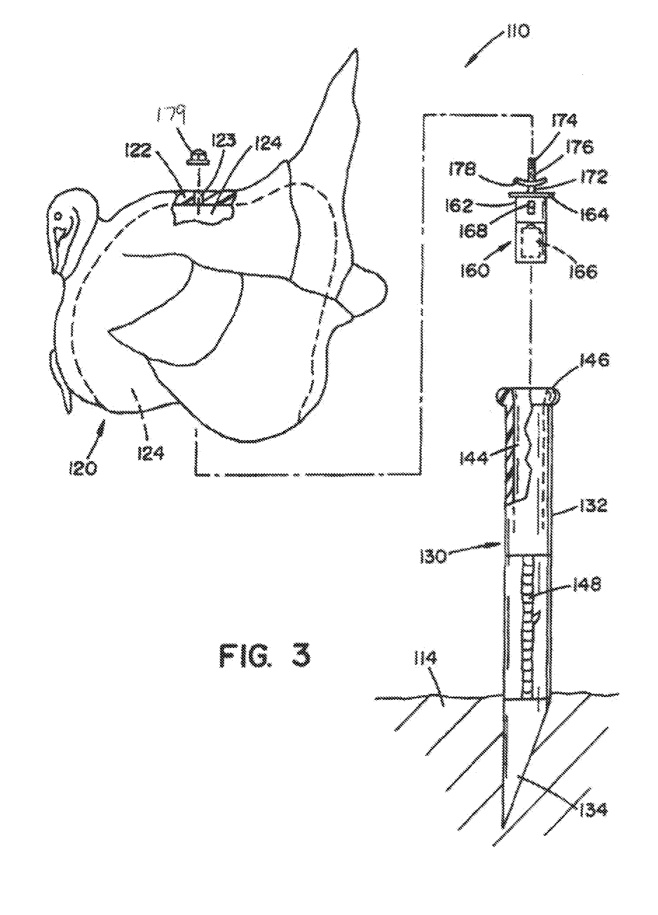

Referring now to an alternative embodiment as shown in FIG. 3, one-hundred-series reference numbers are used to designate elements of a motorized decoy 110. Elements in the alternative embodiment having reference numbers with like ones portions in common with reference numbers of elements in the embodiment described above are analogous to and generally similar to those elements except where otherwise noted. In addition, these elements can be understood by the description of the elements above.

Continuing to refer to the alternative embodiment shown in FIG. 3, a motorized decoy 110 includes a stake 130 that is configured to be inserted into ground 114 such that a decoy body 120 is supported. Body 120 includes a wall 122 that defines a cavity 124. An opening 123 is formed in wall 122 such that an attaching tip 174 of stake 130 can extend there-through. Positioned opposite attaching tip 174 is a ground tip 134. Ground tip 134 is positioned on an end of shaft 132. Ground tip 134 is configured to be retained within ground 114 and to better enable insertion into ground 114.

Stake 130 has an exterior surface that has graphics 148 positioned thereon. In the illustrated embodiment, graphics 148 are chosen to mimic the legs of a turkey. It should be appreciated that graphics 148 could be chosen to mimic a portion of a turkey or other game bird in a realistic manner or in an abstract manner. In this regard, graphics 148, and the exterior surface shape and contour of stake 130, are generally chosen to be perceived by a game bird such that the appearance of stake 130 does not spook, and even assists in attracting, the game bird to a desired location.

Stake 130 includes a housing 144 that is positioned away from tip 134 and includes a rim 146. As shown in FIG. 3, housing 144 defines an exterior profile that generally matches and continues the exterior profile of stake 130. Housing 144 is configured to receive a power unit 160 that is substantially similar to power unit 60 and can be understood from a description thereof where corresponding numbers of the ones series and of the one-hundred series should be understood as being substantially similar. Power unit 160 includes a motor 162. Power unit 160 can be substituted for power unit 60 described above.

Motor 162 includes a motor shaft 172 that extends therefore such that motion and power can be transmitted from motor 162 via shaft 172 to body 20. Shaft 172 extends from motor 162 to attaching tip 174. Attaching tip 174 is threaded for receiving an attachment device, a nut 179, that is configured to securely engage wall 22 of body 20 to a securement 178 and to rest against an annular flange 164. A light emitting element 176 is positioned on attaching tip 174. In the illustrated embodiment, a battery 166 is configured to provide power to light emitting element 176 through an electrical circuit which can be completed or interrupted by a switch 168 as is generally understood.

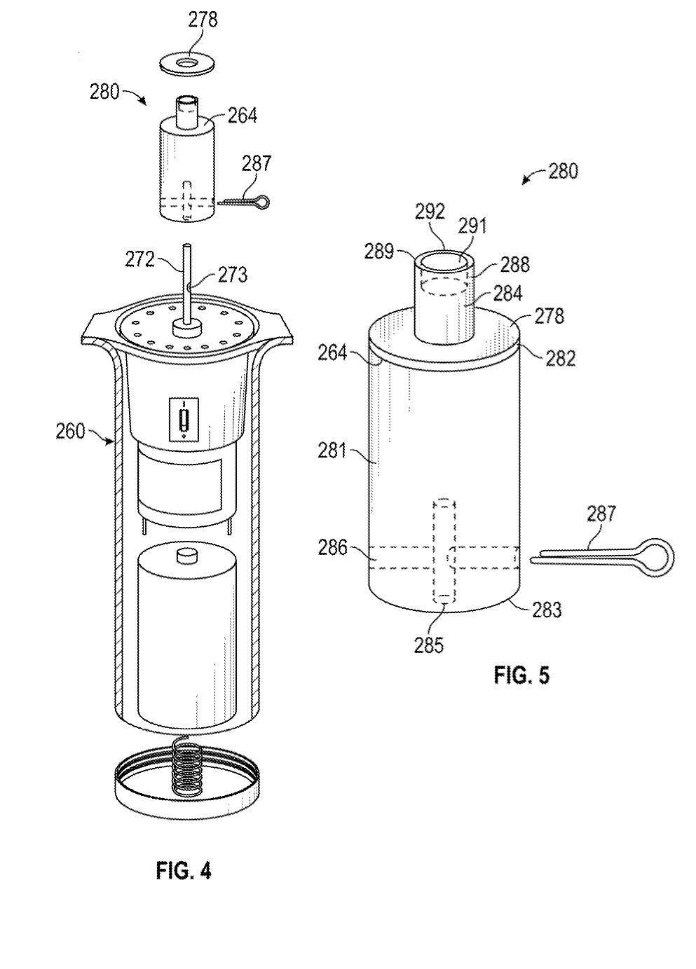

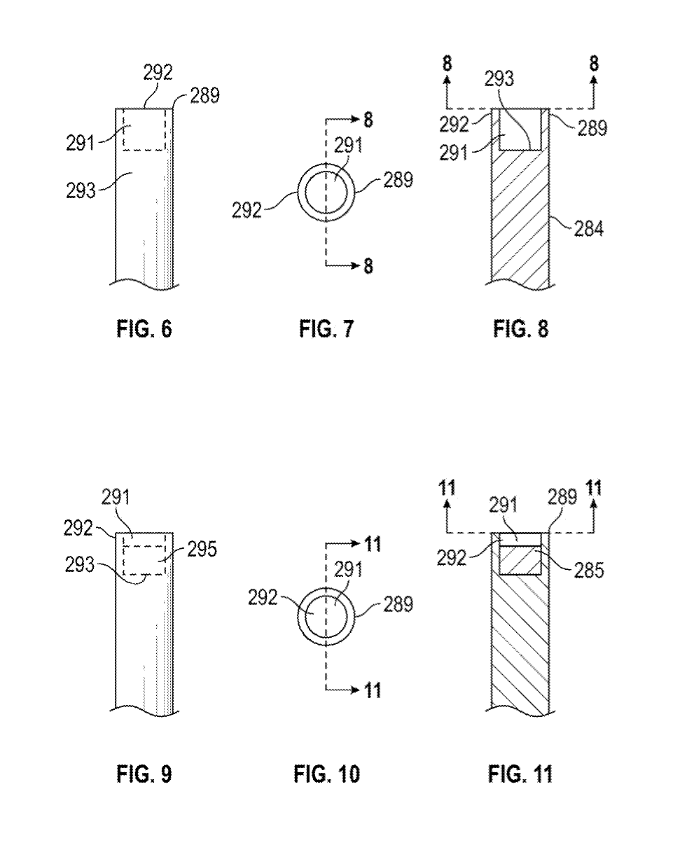

Referring now to another alternative embodiment as shown in FIGS. 4-11, two-hundred-series reference numbers are used to designate elements of a power unit 260 for a motorized decoy 10. Power unit 260 can be substituted for power unit 60 described above. Elements of power unit 260 in the alternative embodiment having reference numbers with like ones portions in common with reference numbers of elements in power unit 60 described above are analogous to and generally similar to those elements except where otherwise noted. Power unit 260 is configured to be substituted for power unit 60 in relation to housing 44. In this regard, power unit 260 is configured to relate to housing 44 in a manner substantially similar to the way that of power unit 60 relates to housing 44.

As shown in FIG. 5, power unit 260 includes a top portion 280. Top portion 280 includes a generally cylindrical base 281 that has a first end 282 and a second end 283. A post 284 extends from first end 282. A receiver 285 is defined in second end 283 of base 281. Receiver 285 is a cylindrical space having an open end and a closed end. Receiver 285 is generally coaxial with base 281. Receiver 285 is configured to receive shaft 272 of a motor 262. A locking hole 286 is defined through based 281 such that locking hole 286 intersects with and is fluidly connected to receiver 285. Locking hole 286 is configured to receive a cotter pin 287 such that cotter pin 287 passes through passage 273 defined in shaft 272 of motor 262 when shaft 272 is positioned within receiver 285. In this manner, base 281 is fixed to shaft 272 such that movement of shaft 272 determined by motor 262 causes movement in base 281. Referring now to FIGS. 5-8, post 284 has threads defined on an outer surface thereof near a distal end of post 284 which defines an annular wall or shield 289. The threads are configured to receive nut 79 in the manner that nut 79 is received on attaching tip 74 as described above. Shield 289 defines a generally cup-shaped pit 291 defined therein. Pit 291 is generally circular and substantially coaxial with an imaginary extension of the axis of base 281. Pit 291 extends from an open end 292 to a bottom 293 and is defined on the side by wall surfaces 294. An annular flange 264 is configured to support an attachment 278.

Referring now to FIGS. 9-11, pit 291 is configured to receive a light-emitting substance 295. In one embodiment, light-emitting substance 295 is contained with pit 291 such that substance 295 does not extend beyond open end 292 of pit 291. In this way light emitting substance 295 is substantially obscured when post 284 is viewed from the side but clearly visible when viewed from above. Thus light from substance 295 is more difficult to see from the side than from above.

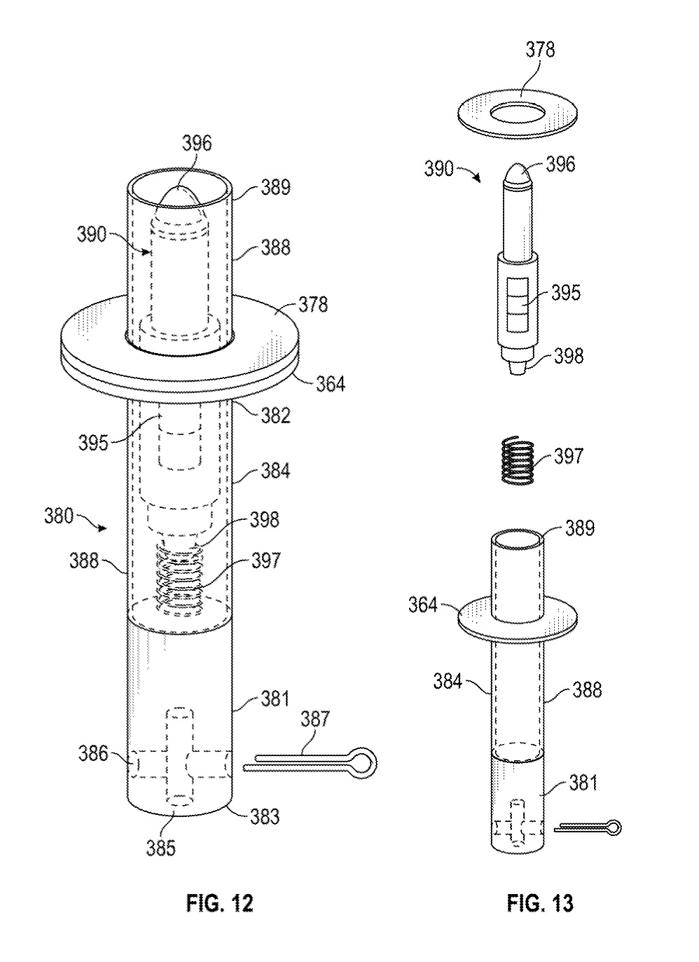

Referring now to another alternative embodiment as shown in FIGS. 12-13, three-hundred-series reference numbers are used to designate elements of a top portion 380 that is configured to be substituted for top portion 280 described above. Elements in the present alternative embodiment having reference numbers with like ones portions in common with reference numbers of elements in the embodiments described above are analogous to and generally similar to those elements except where otherwise noted.

Referring now to FIGS. 12 and 13, top portion 380 includes a generally cylindrical base 381 that has a first end 382 and a second end 383. A receiver 385 is defined in second end 383 of base 381. Receiver 385 is a circular opening having an open end and a closed end and is generally coaxial with base 381. Receiver 385 is configured to receive shaft 272 of motor 260 described above. A locking hole 386 is defined through base 381 such that locking hole 386 intersects with and is fluidly connected to receiver 385. It should be appreciated that the manner in which top portion 380 is attached to motor 260 can be understood by the description of the manner in which top portion 280 attaches to motor 260 above.

Continuing to refer to FIGS. 12 and 13, a tube 388 extends away from base 381 of top portion 380 to a distal end that defines a shield 389. Tube 388 is generally cylindrical and is configured to receive a light emitting device 390 and batteries 395. It should be appreciated that tube 388 has a retaining shoulder (not shown) defined therein that is configured to retain light emitting device 390 as is conventionally known.

Light emitting device 390 includes a light source 396 that is electrically connected to batteries 395 through a circuit that can be interrupted or completed by a switch 398 as is generally understood. In this regard, a spring 397 is configured to bias light emitting device 390 away from top end 382 of base 381. Movement of light emitting device 390 toward base 381 causes switch 398 to engage base 381 such that switch 397 changes states such that light emitting device 390 emits light or does not emit light. Light source 396 is positioned such that light emitted from light source 396 is substantially obscured by shield 389 when post 384 is viewed from the side but clearly visible when viewed from above.

In the illustrated embodiment, light emitting device 390 can be activated by moving device 390 toward base 381 such that switch 398 is operated. In this manner an electrical circuit is completed and light source 396 emits light. Light emitting device 390 can be deactivated in a like manner. It should be appreciated that in other embodiments, light emitting device 390 is configured to obtain electricity from a source of electricity via an electrical circuit that is configured to be interrupted by another type of switch. Annular flange 364 is configured to support an attachment 378.

The present invention can be better understood by a description of the operation of motorized decoy 10 as shown in FIGS. 1 and 2. Motorized decoy 10 can be transported by a hunter to the site of the hunt disassembled such that body 20, stake 30, and power unit 60 are not in the final configuration. When the desired location is reached, the user pushes stake 30 into the ground using step 36. The location is chosen with regard to the immediate landscape and other decoys, if any. After stake 30 is inserted into ground 14, rod 38 is positioned such that attaching tip 74 is a predetermined distance from the ground 14. Collet 42 is secured such that rod 38 is held substantially in positioned relative to shaft 32. In this manner, stake 30 is positioned at a predetermined length.

Power unit 60 is then positioned in housing 44. Switch 68 is activated such that power unit 60 provides motion to body 20 and light emitting element 76 is activated if necessary. It should be appreciated that the step of activating switch 68 can occur after body 20 is attached to power unit 60. To attach body 20 to power unit 60, the user of the motorized decoy 10 then visually determines the location of tip 74 by sighting through body 20 and aligns it with opening 23. It is believed that such alignment is aided because of the increased visibility provided by light emitting element 76. It should be appreciated that in some embodiments light is not visible from a direction other than substantially parallel to an imaginary extension of the axis of shaft 72, i.e., from above. In this regard when power unit 60 is substituted by either power unit 260 or 360, light can easily seen above. In contrast, light is substantially obscured when viewed from the side. Body 20 is positioned such that attaching tip 74 extends through opening 23 of body 20. Nut 79 is threaded or otherwise placed onto attaching tip 74 such that securement 78 is engaged with body 20 and body 20 is secured to stake 30. Visual location of tip 74 relative to body 20 and nut 79 is critical to efficient installation of decoy 10. In early morning hours, or other conditions when visibility is low, light emitting element 76 generates enough light such that tip 74 can be located and properly aligned with opening 23 and nut 79. But not so much light that the hunt is adversely affected.

Referring now to the operation of the alternative embodiment designated with the 200 series reference numbers, to attach body 20 to power unit 260, the user of the motorized decoy 10 then visually determines the location of tip 284 by sighting through body 20 and aligns tip 284 with opening 23. It is believed that such alignment is aided because of the increased visibility provided by light emitting substance 295. It should be appreciated that in some embodiments light is not visible from a direction other than substantially parallel to an imaginary extension of the axis of shaft 272, i.e., from above. In this regard when power unit 60 is substituted by either power unit 260, light can easily seen from above. In contrast, light is substantially obscured when viewed from the side. Body 20 is positioned such that attaching tip 284 extends through opening 23 of body 20. Nut 79 is threaded or otherwise placed onto attaching tip 284.

Referring now to the operation of the alternative embodiment designated with the 300 series reference numbers, top unit 380 is engaged with motor 260. Then switch 398 is operated such that light emitting source 390 is activated. Then the step of attaching body 20 is begun. The user of the motorized decoy 10 then visually determines the location of tip 384 by sighting through body 20 and aligns tip 384 with opening 23. It is believed that such alignment is aided because of the increased visibility provided by light emitting source 290. It should be appreciated that in some embodiments light is not visible from a direction other than substantially parallel to an imaginary extension of the axis of shaft 272, i.e., from above. Body 20 is positioned such that attaching tip 384 extends through opening 23 of body 20. Nut 79 is threaded or otherwise placed onto attaching tip 384.

In this manner motorized decoy 10 is initiated and installed such that can game birds can be attracted thereto. Once the apparatus is activated, it will produce the natural motions and rotations of a strutting male wild turkey. The battery operated revolving stake apparatus must be switched on at time of decoy set-up and will rotate continuously at 2 to 4 revolutions per minute. The battery operated revolving stake apparatus may be used in conjunction with a variety of hollow body molded decoys and is not limited to the male wild turkey decoy.

Generally body 20 will rotated between about 2 and about 4 revolutions per minute. The presence or absence of wind during while decoy 10 is activated can affect the motion of body 20. Generally the presence of wind can further enhance motion realism with additional movement and inconsistent rotation.

To summarize, this invention includes a manual switch for on/off activation of a single battery operated revolving decoy stake designed to support and impart natural motions to a turkey decoy. The revolving stake apparatus is removable and can be attached to the body of a turkey decoy. Once the apparatus is activated, it will produce the natural motions and rotations of a strutting male wild turkey. The battery operated revolving stake apparatus must be switched on at time of decoy set-up and will rotate continuously at 2 to 4 revolutions per minute. The battery operated revolving stake apparatus may be used in conjunction with a variety of hollow body molded decoys and is not limited to the male wild turkey decoy. The plastic/PVC base stake, which holds the battery operated revolving motor is photo realistically enhanced with authentic turkey legs to fool the wariest of male wild turkeys. The tip of the extension shaft has a light emitting feature allowing easy set up during early morning low-light conditions while emitting less light when viewed from the side.

It is believed that features of the present invention represent improvements over conventional decoys and decoy supports. In this regard, a suitable battery 66 has been tested to demonstrate an operation life has been tested for continuous, non-stop use over 20 hours. In addition, in a preferred embodiment, the support stake 30 weighs just over 1 pound such that it is lightweight and not bulky. It is believed that under some circumstances, motorized decoy 10 can be set up in 15 seconds. It is also believed that the illustrated embodiments described above can be produced at low costs such that a motorized decoy according to the present invention is more economical that a conventional motorized decoy.

While the present invention has been illustrated and described with reference to preferred embodiments thereof, it will be apparent to those skilled in the art that modifications can be made and the Invention can be practiced in other environments without departing from the spirit and scope of the invention, set forth in the accompanying claims.

Having described the invention, the following is claimed:

1. A decoy support for positioning and imparting movement to decoy bodies such as game bird decoy bodies, the decoy support comprising:
a stake that includes a housing positioned at one end of the stake;
a power-supply unit configured to be received within the housing;
a shaft that is configured to transmit motion from the power-supply unit and that extends from the power supply unit to extends from the power-supply unit;
a distal end of the shaft defining a recessed space; and
a light source positioned within the space.

2. A decoy support according to claim 1, wherein in the space extends to an open end.

3. A decoy support according to claim 2, wherein the light source does not extend past the open end.

4. A decoy support according to claim 1, wherein the light source is electrically powered.

5. A motorized decoy support according to claim 1, wherein the tip is configured to enhance its visibility in low-light conditions.

6. A motorized decoy support according to claim 1, wherein the light source is a light emitting substance.

7. A motorized decoy support according to claim 6, wherein the light emitting substance is phosphorescent.

8. A motorized decoy support according to claim 1, wherein the light emitting substance is positioned within the space such that light emitted from the light source can be seen from a point positioned along an imaginary extension of an axis of the shaft.

9. A motorized decoy support according to claim 8, wherein the light source is positioned within the space such that the light source cannot be seen along a line of sight that is generally perpendicular to the imaginary extension of the axis of the shaft.

10. A method for installing a decoy for a game bird, the method comprising the steps of:
providing a stake that includes a housing positioned at one end of the stake, a power-supply unit configured to be received within the housing, a shaft for transmitting motion extending from the power-supply unit, an end of the shaft being tubular and open on at least one end, a space defined within the tubular portion of the shaft, and a light source that is positioned within the space such that the light source does not extend past the open end of the shaft;
providing a decoy body that has a passageway formed therethrough for receiving the shaft;
providing an attachment device configured to secure the decoy body to the end of the shaft;
pushing the stake into ground;
positioning the power supply unit within the housing;
positioning the decoy body such that the open end of the shaft can be maneuvered relative to the end of the shaft;
sighting light emitted from the light emitting device by viewing through the passageway of the decoy body;
positioning the decoy body such that the shaft extends through the decoy body;
aligning the tip with the attachment device; and
securing the attachment device to the end of the shaft and thus securing the decoy body to the stake.

11. A method for installing a decoy according to claim 10, the method comprising the further step of activating the power unit.

12. A method for installing a decoy according to claim 10, the method comprising the further step of visually determining the location of the tip relative to the attachment device with the aid of light emitted from the tip.
